(19) United States
(12) Patent Application Publication
(10) Pub. No.: US 2008/0251209 A1
(43) Pub. Date: Oct. 16, 2008

(54) AUTOMATIC ELASTIC BAND FUSION APPARATUS FOR FACE MASK

(76) Inventor: Hung-Ho Chen, Tu Cheng City (TW)

Correspondence Address: LEONG C LEI, PMB # 1008, 1867 YGNACIO VALLEY ROAD, WALNUT CREEK, CA, 94598, US

(21) Appl. No.: 11/735,504

(22) Filed: Apr. 16, 2007

(51) Int. Cl. B26D 5/00

(52) U.S. Cl. 156/354

(57) ABSTRACT

An automatic elastic band fusion apparatus is disclosed for fusing an elastic band to a face mask. The apparatus includes a conveyance carrier movable along a track arranged in an operation platform for conveying the face mask, a band feeding device for driving the elastic band to a predetermined length and then cutting and retaining the band, and a pickup turn table, which picks up the cut band and positions the cut band at a desired location with respect to the face mask for fusion, wherein the platform allows the face mask to be conveyed by the carrier, while the elastic band can be fed in directly for fusing to the face mask.

### BACKGROUND OF THE INVENTION

(a) Technical Field of the Invention

The present invention relates to an automatic fusion apparatus for directly fusing an elastic band to a face mask, and in particularly to an apparatus that comprises a platform on which cutting a fusion of the elastic band is carried out.

(b) Description of the Prior Art

Currency, the process for fusing an elastic band to a face mask comprises the following steps: cutting an elastic band to a predetermined length, followed by fusing the cut band to the face mask. In other words, the elastic band has to be prepared in advance before the fusion is carried out. Both steps are time- and labor-consuming. This gives significant influences over the overall costs of face mask. Further, since this operation is performed manually, quality control cannot be ensured and mass product is difficult, leading high costs.

Further, after the fusion of the elastic band to the face mask is completed, packaging of the face mask must be subsequently carried out, which includes manually folding the elastic band into an inner side space of the face mask, and then folding the face mask, followed by positioning the folded face mask in a packaging container. This is also a manual operation and takes time and labor.

Thus, the present invention is aimed to overcome the above discussed problems try providing an apparatus capable of automatically fusing an elastic band to a face mask.

### SUMMARY OF THE INVENTION

The primary purpose of the present invention is to provide an automatic elastic band fusion apparatus for a face mask comprising: a conveyance carrier, a ban feeding device, and a pickup turn table, wherein the conveyance carrier is arranged on and movable along a track arranged in an operation platform for conveying the face mask, the band feeding device drives the elastic band to a predetermined length and then cuts and retains the band, and the pickup turn table picks up the cut band and positions the cut band at a desired location with respect to the face mask for fusion, whereby feeding, cutting and fusion of the band to the face mask is directly carried out on the platform.

Further, the automatic elastic band fusion apparatus is further provided with a band positioning device for positioning the band at an inner side of the face mask. The band positioning device comprises a band driving rod, a band folding carrier, a folding arm, and a band retainer, serving to move the cut band to a location at the inner side of the face mask for properly positioning of the band inside the face mask.

The automatic elastic band fusion apparatus further comprises a mask folding device and a mask pickup device. The mask folding device comprises at least one folding clamp, which grips over an outer side of the face mask so as to fold the face mask with the elastic band located inside the face mask. The mask pickup device comprises a pickup clamp for gripping and picking up and moving the folded mask out of the conveyance carrier.

The conveyance carrier comprises a carrier chassis, at least one roller, a retention plate, and a band support rack. The roller is coupled to the chassis to allow the chassis to move. The retention plate is arranged on the chassis for pressing and retaining the face mask in an expanded condition. The band support rack is arranged above the retention plate and forms at least one hanger for receiving and holding the elastic band in position without undesired movement.

The band feeding device comprises a retention clamp, an elongating arm, and a cutter, wherein the retention clamp is arranged at a band feed-in opening for clamping and holding the elastic band. The elongating arm comprises an elongating clamp for driving the elastic band, whereby when the elongating arm drives the elastic band to a predetermined length, the retention clamp and the elongating arm cooperate to hold the elastic band. The cutter is then employed to cut off the band at a location around or outside the retention clamp to complete the preparation of the elastic band.

The pickup turn table comprises a pickup arm, a band guide, a fusion base and a fusion member, wherein the pickup arm comprises at least one pickup clip for holding the cut band. The band guide escorts the cut band to the conveyance carrier after the pickup turn table is rotated to a desired position and the cut band is released. The fusion base is arranged on the pickup turn table whereby when the pickup turn table is rotated to a predetermined position, the fusion base is located on an inner side of the mask. The fusion member is arranged on the pickup turn table whereby when the pickup turn table is rotated to the predetermined position, the fusion member is located at an outer side of the face mask and opposite to the fusion base.

The apparatus employs the conveyance carrier to convey the face mask while the preparation of the elastic band is conducted. Adhering of the elastic band to the face mask is then carried out in the apparatus, and thereafter, the mask folding device and mask pickup device are used to automatic folding the mask and positioning the folded mask to a desired location. Thus, fusion of the elastic band to the face mask can be automatically and directly done to thereby realize consistent quality, reduction of labor, and increase of throughput.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 illustrates an automatic elastic band fusion apparatus constructed in accordance with the present invention;

FIGS. 2A-2G illustrate the operation of a band feeding device of the automatic elastic band fusion apparatus of the present invention;

FIGS. 3A-3E illustrate the operation of a pickup turn table of the automatic elastic band fusion apparatus of the present invention;

FIGS. 4A-4G illustrate the operation of an elastic hand positioning device of the automatic elastic band fusion apparatus of the present invention;

FIGS. 5A and 5B illustrate the operation of a mask folding device of the automatic elastic band fusion apparatus of the present invention; and

FIGS. 6A and 6B illustrate the operation of a mask pickup device of the automatic elastic band fusion apparatus of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

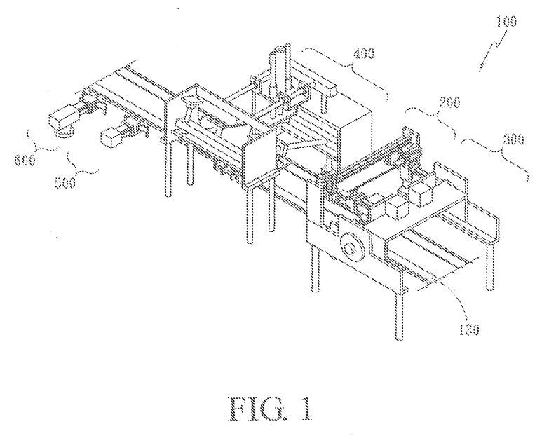

With reference to the drawings and in particular to FIG. 1, an automatic elastic band fusion apparatus constructed in accordance with the present invention, generally designated with reference numeral 100, is provided for fusion of an elastic band to a face mask. The automatic elastic band fusion apparatus generally comprises a band feeding device 200, a pickup turn table 300, an elastic band positioning device 400, a mask folding device 500, and a mask pickup device 600. A conveyance carrier 140 is also incorporated for conveying the face mask. The band feeding device 200 functions in drive an elastic band to a desired length and to cut and retain the desired length of the elastic band. The pickup turn table 300 serves to take and cut band and to move the cut band to a position corresponding to the face mask for subsequent fusion. With the above devices, while the face mask is being conveyed by the conveyance carrier, the elastic band is directly fed, cut, and fused to the face mask that is being conveyed by the carrier. The mask folding device 500 then functions to fold the mask to which the elastic band is fused and the mask pickup device 500 serves to remove the folded mask from the conveyance carrier to a predetermined position.

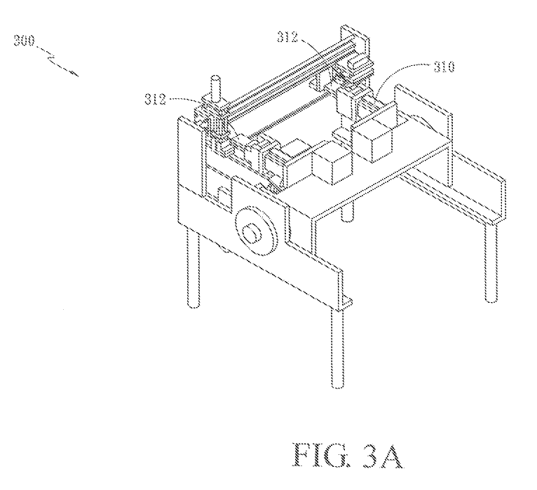

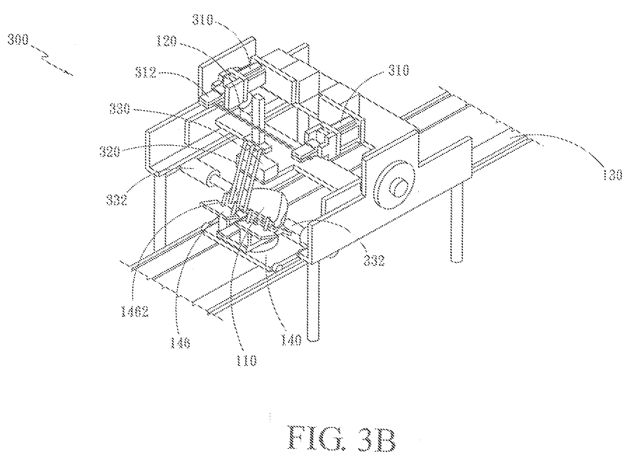

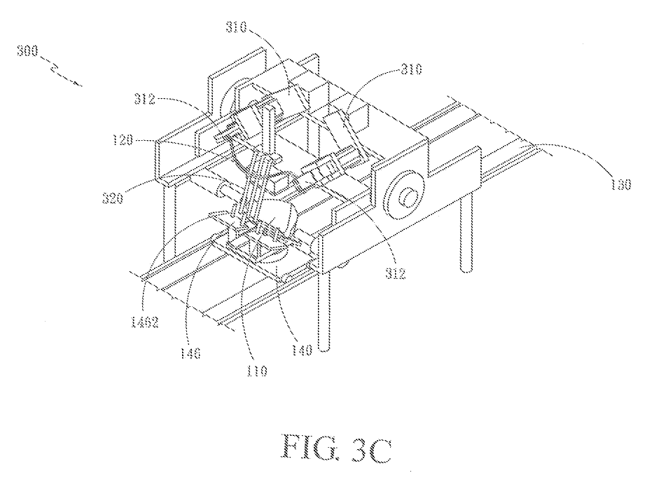

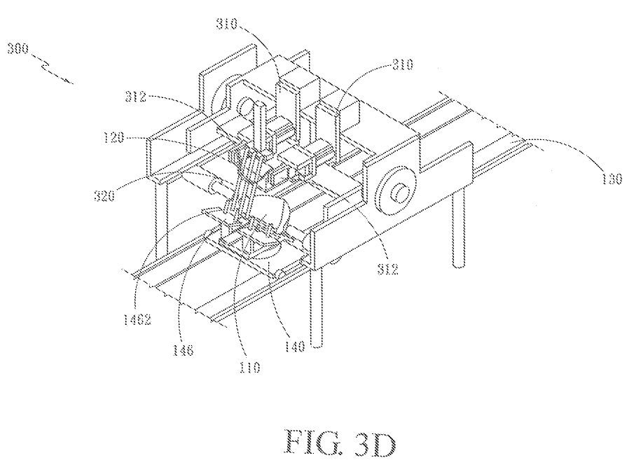

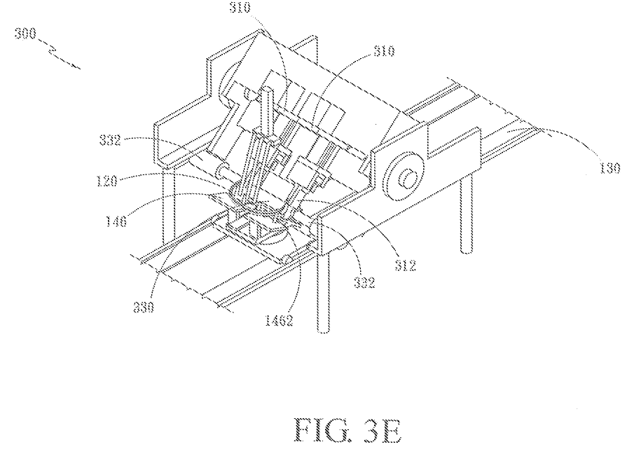

Referring to FIG. 3B, the conveyance carrier 140 comprises a chassis 142, four rollers 1422, a retention plate 144, and a band support rack 146. The rollers 1422 are mounted to the chassis 142 to allow the carrier 140 to move. The retention plate 144 mounted to the top side of the carrier chassis 142 for retaining the face mask on the chassis 142 in an expanded condition. The band support rack 146 is arranged above the retention plate 1444 and forms at least one hanger 1462 to maintain the elastic band in position without arbitrary movement.

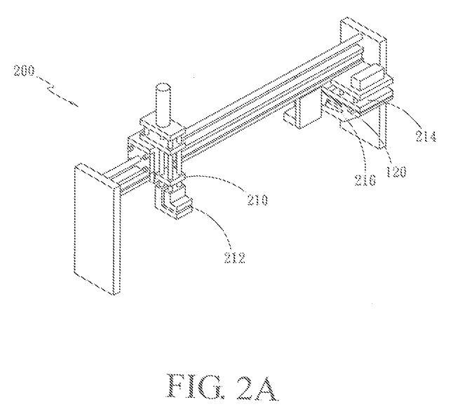

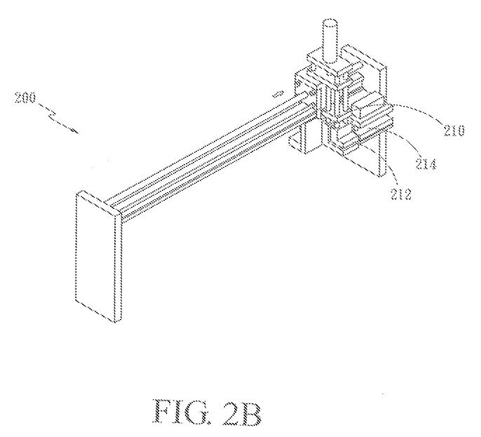

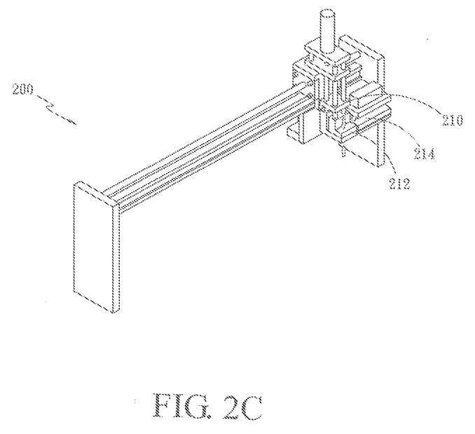

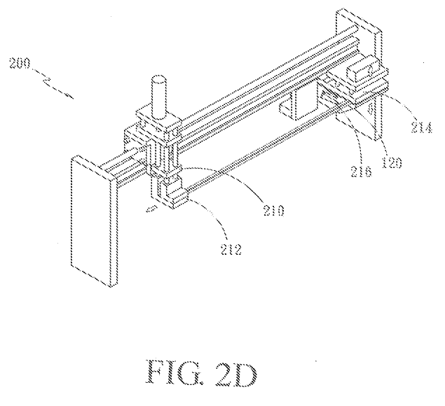

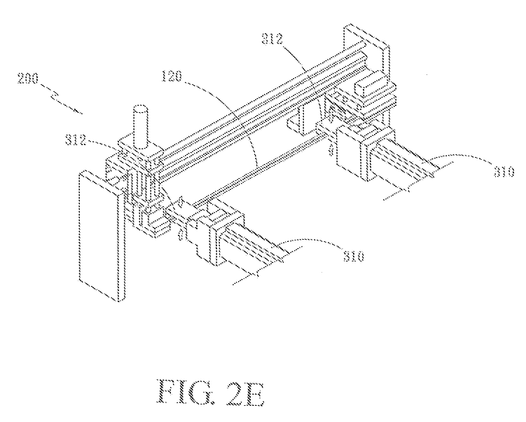

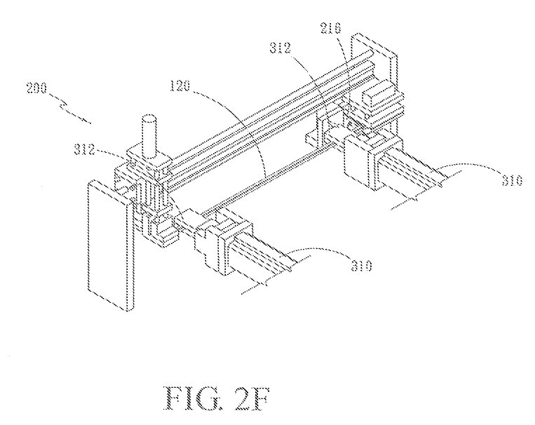

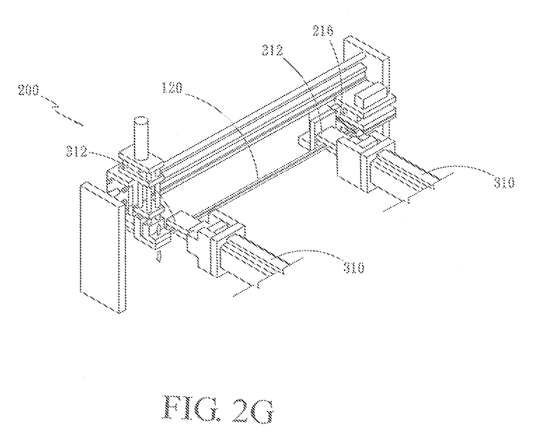

Referring to FIGS. 2A-2G, the band feeding device 200 is illustrated. The band feeding device 200 comprises a retention clamp 214, an elongating arm 210, and a cutter 216, such as scissors. The retention clamp 214 is arranged at a band feed-in opening to securely retain the elastic band after the elastic band is pulled and set a predetermined position. The elongating arm 210 is provided with an elongating clamp 212 for driving the elastic band and the elongate arm 210 elongates the elastic band to a predetermined length, where the retention clamp 214 and the elongating arm 210 cooperate to securely hold the elastic band. A pickup clip 312 of a pickup arm 310 (both being parts of the pickup turn table 300) is then operated to grip the elastic band, and the cutter 216 is then operated to cut off the elastic band at or outside the location of tire retention clamp 214. This completes the preparation of the elastic band to be fused to the face mask.

Referring to FIGS. 3A-3E, the pickup turn table 300 comprises two pickup arms 310, a band guide 320, a fusion base 330, and a fusion member 332. Each pickup arm 310 comprises a pickup clip 312 for gripping and holding the cut band. With the cut hand held on the pickup clips 312, the pickup turn table 300 is rotated, followed by inward turning of the pickup arms 310, the cut band is allowed to move along the band guide 320 to the hangers 1462 of the conveyance carrier 140. The fusion base 330 is arranged on the pickup turn table 300 whereby when the pickup turn table 300 is rotated to a predetermined position, the fusion base 330 is located on an inner side of the mask. The fusion member 332 is arranged on the pickup turn table 300 whereby when the pickup turn table 300 is rotated to the predetermined position, the fusion number 332 is located at an outer side of the face mask at a location opposite to the fusion base 330. The fusion base 330 provides a support to the face mask, while the fusion member 332 carries out fusion operation.

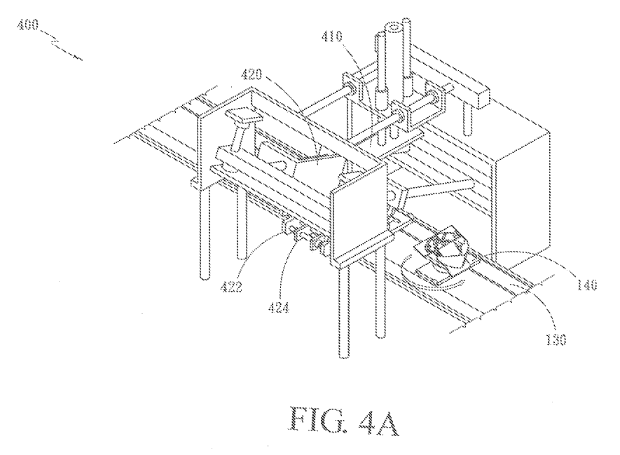

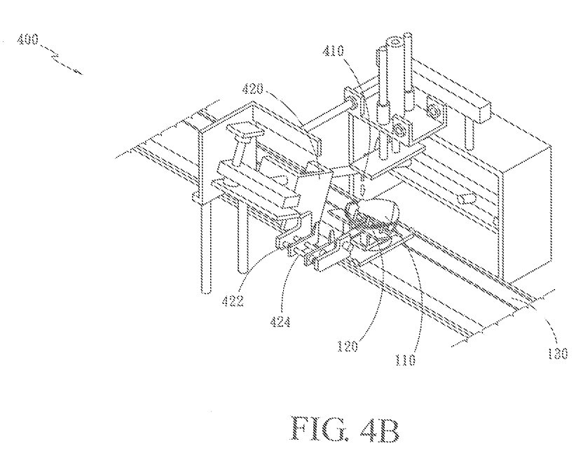

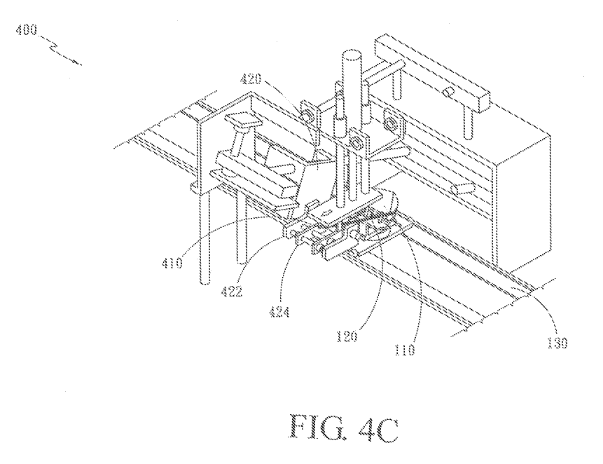

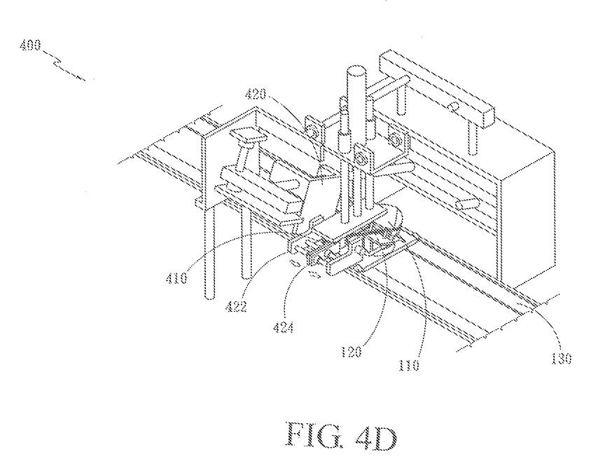

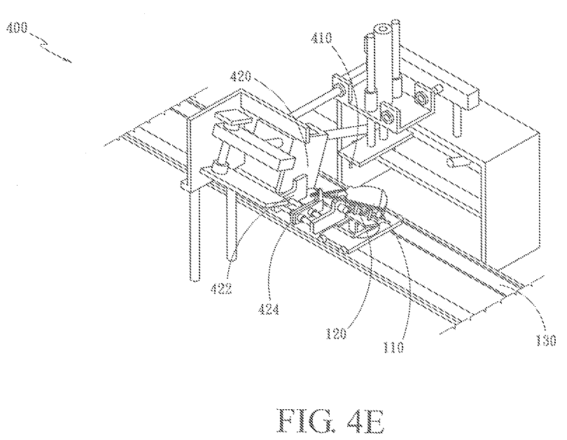

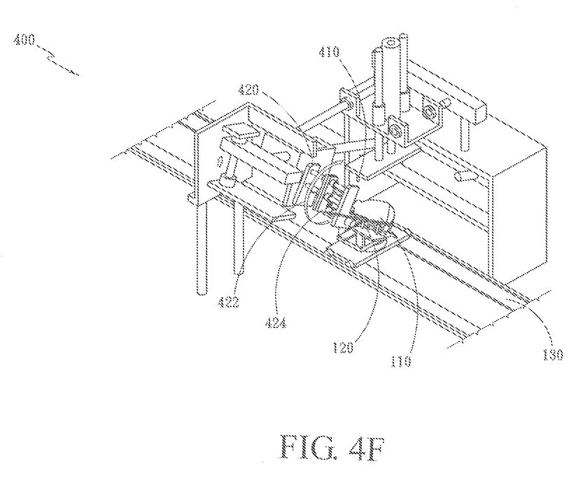

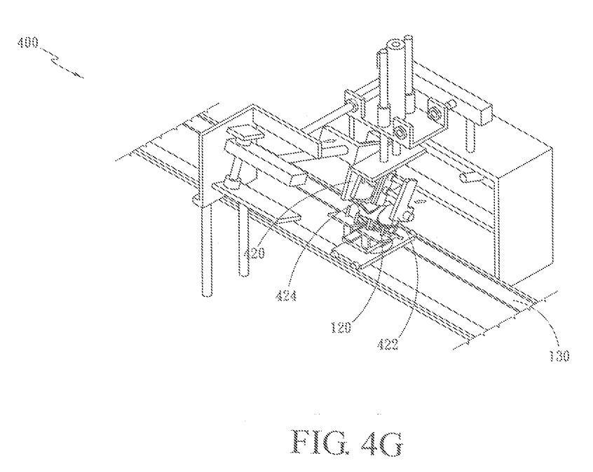

Referring to FIG. 4A-4G, the elastic band positioning device 400 is illustrated. The elastic band positioning device 400 comprises a band driving rod 410, a band folding, carrier 420, a folding arm 422, and a band retainer 424, serving to move the cut band to a location at the inner side of the face mask for properly positioning the band inside the face mask. The driving rod 410 stretches the band held on the hangers 1462 of the carrier 140 to a location to be retained by the band retainer 424. The folding arm 422 is then rotated toward the inner side of the face mask to move the band retainer 424 to the inner side of the face mask. At this moment, the band retainer 424 releases the band, which then drops down to get located inside the face mask.

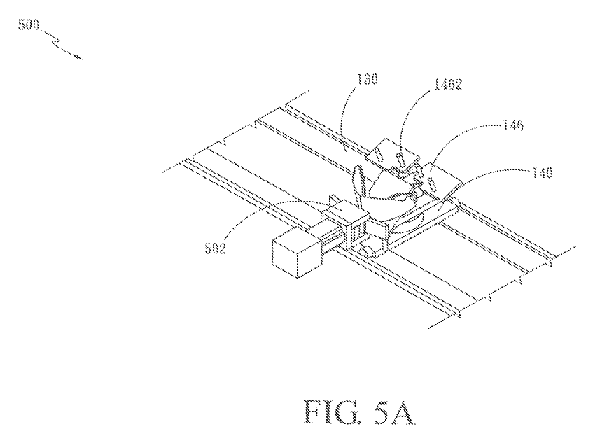

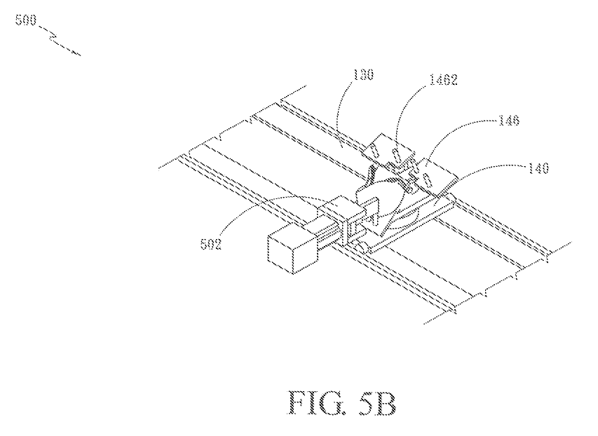

Referring to FIGS. 5A and 5B, the mask folding device 500 comprises a folding clamp 502, which grips over the outer side of the face mask so as to fold the mask. The face mask so folded is maintained at the folded condition by a metal wire included therein. At this time, the elastic band is still located inside the face mask.

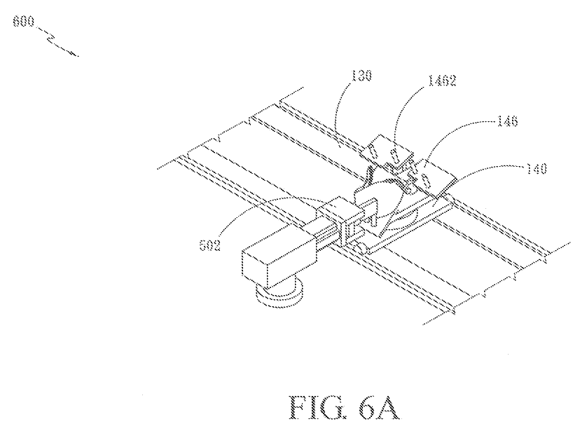

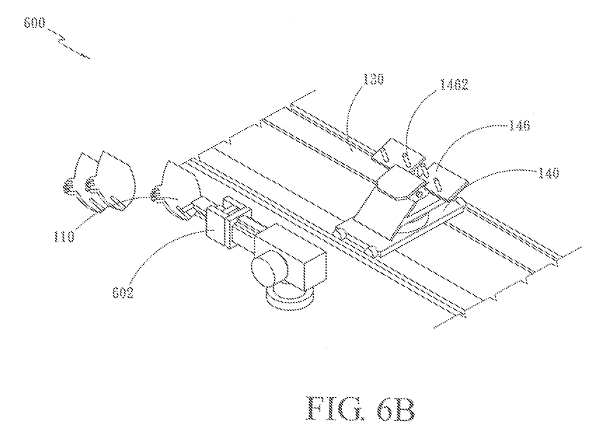

Referring to FIGS. 6A and 6B, the mask pickup device 600 comprises a pickup clamp 602, which serves to grip and pick up and move the folded mask out of the conveyance carrier and put the mask to a predetermined location.

Although the present invention has been described with reference to the preferred embodiment thereof, it is apparent to those skilled in the art that a variety of modifications and changes may be made without departing from the scope of the present invention which is intended to be defined by the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An automatic elastic band fusion apparatus for a face mask comprising:
a conveyance carrier movable along a track arranged in an operation platform for conveying the face mask;
a band feeding device for driving an elastic band to a predetermined length and then cutting and retaining the band; and
a pickup turn table, which picks up the cut band, and positions the cut band at a desired location with respect to the face mask for fusion;
wherein feeding, cutting and fusion of the band to the face mask is carried out on the platform.

2. The automatic elastic band fusion apparatus as claimed in claim 1 further comprising a band positioning device for positioning the band at an inner side of the face mask.

3. The automatic elastic band fusion apparatus as claimed in claim 1 wherein the conveyance carrier comprises:
a carrier chassis;
at least one roller coupled to the chassis;
a intention plate arranged on the chassis for pressing and retaining the face mask; and
a band support rack arranged above the retention plate and forms at least one hanger.

4. The automatic elastic band fusion apparatus as claimed claim 2 wherein the conveyance carrier comprises:
a carrier chassis;
at least one roller coupled to the chassis;
a retention plate arranged on the chassis for pressing and retaining the face mask; and
a band support rack arranged above the retention plate and forms at least one hanger.

5. The automatic elastic band fusion apparatus as claimed in claim 2, wherein the band positioning device comprises a band driving rod, a band folding carrier, a folding arm, and a band retainer.

6. The automatic elastic band fusion apparatus as claimed in claim 4 further comprising a mask folding device and a mask pickup device.

7. The automatic elastic band fusion apparatus as claimed in claim 5, wherein the mask folding device composes at least one folding clamp, which grips over an outer side of the face mask so as to fold the face mask.

8. The automatic elastic band fusion apparatus as claimed in claim 5, wherein the mask pickup device comprises a pickup clamp for gripping and picking up and moving the folded mask out of the conveyance carrier.

9. The automatic elastic band fusion apparatus as claimed in claim 1 wherein the hand feeding device comprises:
a retention clamp arranged at a band feed-in opening;
an elongating arm comprising an elongating clamp; and
a cutter for cutting off the band;
wherein the elongating arm drives the elastic band to a desired length where the elastic band is retained by die retention clamp to allow the cutter to cut off the band.

10. The automatic elastic band fusion apparatus as claimed in claim 2 wherein the band feeding device comprises:
a retention clamp arranged at a band feed-in opening;
an elongating arm comprising an elongating clamp; and
a cutter for cutting off the band;
wherein the elongating arm drives the elastic band to a desired length where the elastic band is retained by tire retention clamp to allow the cutter to cut off the band.

11. The automatic elastic band fusion apparatus as claimed in claim 1, wherein the pickup rum table comprises:
a pickup arm comprising at least one pickup clip for holding the cut band;
a band guide, which guides the cut band toward the conveyance carrier after the cut band is released from the pickup arm;
a fusion base arranged on the pickup turn table whereby when the pickup turn table is rotated to a predetermined position, the fusion base is located on an inner side of the mask; and
a fusion member arranged on the pickup turn table whereby when the pickup turn table is rotated to the predetermined position, the fusion member is located at an outer side of the face mask and opposite to the fusion base.

12. The automatic elastic band fusion apparatus as claimed in claim 2 wherein the pickup turn table comprises:
a pickup arm comprising at least one pickup clip for holding the cut band;
a band guide, which guides the cut band toward the conveyance carrier after the cut band is released from the pickup arm;
a fusion base arranged on the pickup turn table whereby when the pickup turn table is rotated to a predetermined position, the fusion base is located on an inner side of the mask; and
a fusion member arranged on the pickup turn table whereby when the pickup turn table is rotated to the predetermined position, the fusion member is located at an outer side or the face mask and opposite to the fusion base.
